(19) United States
(12) Patent Application Publication
(10) Pub. No.: US 2011/0198204 A1
(43) Pub. Date: Aug. 18, 2011

(54) LIGHT GUIDE SHEET, AND MOVABLE CONTACT UNIT AND SWITCH USING LIGHT GUIDE SHEET

(75) Inventors: NAOKI TATEHATA, Kyoto (JP); HIROTOSHI WATANABE, Osaka (JP)

(73) Assignee: PANASONIC CORPORATION, Osaka (JP)

(21) Appl. No.: 13/025,280

(22) Filed: Feb. 11, 2011

(30) Foreign Application Priority Data
Feb. 18, 2010 (JP) 2010-033115

(51) Int. Cl. H01H 1/06; G02B 6/10

(52) U.S. Cl. 200/275; 385/146

(57) ABSTRACT

A light guide sheet has a light-transmissive film-shaped base material, and a convex first light emitting section formed on the base material. In the first light emitting section, a fluorescent pigment and a dyeing pigment are dispersed. The light guide sheet of the present invention emits light of a pure and vivid color by using the fluorescent pigment and the dyeing pigment.

### BACKGROUND OF THE INVENTION

1. Field of the Invention

The present invention relates to a light guide sheet used in operations of various electronic devices, and a movable contact unit and a switch using the light guide sheet.

2. Background Art

Recently, the number of electronic devices have been increased, which are capable of easily carrying out pushing buttons and recognizing and operating of a display sheet even in dark surroundings by allowing a light emitting diode, EL (Electro Luminescent) element, or the like, to emit light so as to illuminate an operation section. Examples of such electronic devices include portable terminal devices such as a mobile phone and an electronic camera. Furthermore, movable contact units and switches capable of carrying out illumination variously at a low cost have been demanded so that they are mounted on these electronic devices.

FIG. 5 is a partial sectional view showing a conventional movable contact unit. FIG. 6 is a partial sectional view showing a conventional switch. FIGS. 5 and 6 are shown on an expanded scale partially for an easy understanding of configuration.

On the top surface of light-transmissive film-shaped base material 1, a plurality of phosphor layers 3A and 3B in which zinc sulfide and the like is dispersed are formed. Thus, light guide sheet 4 is formed.

Film-shaped base sheet 5 is attached to the lower surface of light guide sheet 4 with an adhesive (not shown) at a predetermined portion of the outer periphery thereof. Dome-shaped movable contact 6 made of a thin metal plate and film-shaped separator 15 are attached to the lower surface of base sheet 5. Thus, movable contact unit 7 is constructed.

On the top surface of wiring board 8 having a plurality of wiring patterns (not shown) on the top and lower surfaces thereof, a plurality of fixed contacts 9 are provided. Fixed contacts 9 include circular center fixed contact 9A and horseshoe-shaped or ring-shaped outer fixed contact 9B surrounding center fixed contact 9A.

On the top surface of wiring board 8, movable contact unit 7 is placed. Outer periphery of movable contact 6 is placed on outer fixed contact 9B, and the center of the lower surface of movable contact 6 faces center fixed contact 9A with a predetermined gap therebetween.

Furthermore, light emitting device 10 such as a light emitting diode is mounted at the side part of light guide sheet 4 on the top surface of wiring board 8. For example, it is disposed on the right end surface of base material 1.

On the lower surface of light-transmissive film-shaped display sheet 11, coated section 11A formed by, for example, printing and display section 11B formed by punching predetermined portions of coated section 11A in shapes of, for example, characters and symbols. Display sections 11B are disposed in the upper part of phosphor layer 3A and phosphor layer 3B. Thus, switch 20 is configured.

Switch 20 is equipped on an operation surface of an electronic device such as a mobile phone. A plurality of center fixed contacts 9A, outer fixed contacts 9B, and light emitting device 10 are connected to an electronic circuit (not shown) of an electronic device via wiring patterns, and the like.

In the above-mentioned configuration, when a user presses down display section 11B position of display sheet 11, light guide sheet 4 and base sheet 5 bend, so that a dome-shaped center part of movable contact 6 is pressed down. When a predetermined pressing force is applied, movable contact 6 is elastically reversed downward with a click feeling, so that the center of the lower surface of movable contact 6 is brought into contact with center fixed contact 9A. As a result, center fixed contact 9A and outer fixed contact 9B are electrically connected to each other via movable contact 6.

Furthermore, when the pressing force applied to display sheet 11 is released, movable contact 6 is elastically reversed upward by an elastic returning force, so that the center of the lower surface of movable contact 6 departs from center fixed contact 9A, and center fixed contact 9A and outer fixed contact 9B are electrically disconnected from each other.

In response to the electrical connection/disconnection of fixed contacts 9, switching of various functions of an electronic device is carried out. Furthermore, when electric power is supplied to light emitting device 10 from an electronic circuit of the electronic device, light emitting device 10 emits light, and the light enters into light guide sheet 4 from, for example, the right end surface and moves to the left side while it is reflected inside base material 1.

At this time, for example, in the case where the emitted light color of light emitting device 10 is ultraviolet ray, when silver-added zinc sulfide is dispersed in phosphor layer 3A, phosphor layer 3A shows a red emitted light color. When copper-added zinc sulfide is dispersed in phosphor layer 3B, phosphor layer 3B shows a green emitted light color.

That is to say, the light from light emitting device 10 passes through phosphor layer 3A or phosphor layer 3B formed in the upper part of light emitting device 10, and thereby the light is converted into light of a red color or a green color. Then, display section 11B in the upper part is illuminated by these different colors.

However, the light that has passed through phosphor layer 3A or phosphor layer 3B has a blurry color, and it may lack in vividness.

### SUMMARY OF THE INVENTION

A light guide sheet of the present invention includes a light-transmissive film-shaped base material, and a convex first light emitting section formed on the base material. In the first light emitting section, a fluorescent pigment and a dyeing pigment are dispersed. With the fluorescent pigment dispersed in the light emitting section, an emitted light color of the light emitting device is converted into a different color. In addition, with the dyeing pigment dispersed in the light emitting section, a complementary color component of the color of light emitted by the fluorescent pigment is absorbed. Thus, the first light emitting section can emit light of a pure and vivid color.

Furthermore, a movable contact unit of the present invention includes the above-mentioned light guide sheet, and a dome-shaped conductive movable contact. A surface on which a light emitting section of the light guide sheet is formed faces the movable contact directly or indirectly. In the movable contact unit of the present invention, with the fluorescent pigment, an emitted light color of the light emitting device is converted into a different color. Furthermore, with the dyeing pigment dispersed in the light emitting section, a complementary color component of the color of light emitted by the fluorescent pigment is absorbed. Thus, light of a pure and vivid color can be emitted.

Furthermore, a switch of the present invention includes the above-mentioned movable contact unit, and a wiring board having a fixed contact and light emitting device. In the switch of the present invention, with the fluorescent pigment, an emitted light color of the light emitting device is converted into a different color. Furthermore, with the dyeing pigment dispersed in the light emitting section, a complementary color component of the color of light emitted by the fluorescent pigment is absorbed. Thus, light of a pure and vivid color can be emitted.

### BRIEF DESCRIPTION OF THE DRAWINGS

FIG. 1 is a partial sectional view showing a movable contact unit to be described prior to an embodiment of the present invention.

FIG. 2 is a partial sectional view showing a switch to be described prior to an embodiment of the present invention.

FIG. 3 is a partial sectional view showing a movable contact unit in accordance with an embodiment of the present invention.

FIG. 4 is a partial sectional view showing a switch in accordance with an embodiment of the present invention.

FIG. 5 is a partial sectional view showing a conventional movable contact unit.

FIG. 6 is a partial sectional view showing a conventional switch.

### DETAILED DESCRIPTION OF THE INVENTION

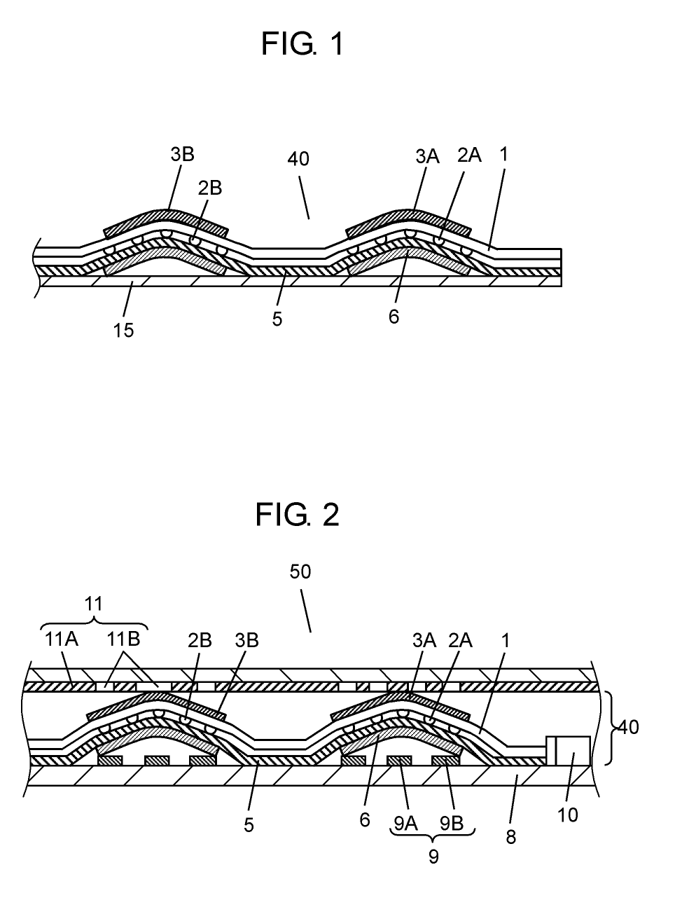

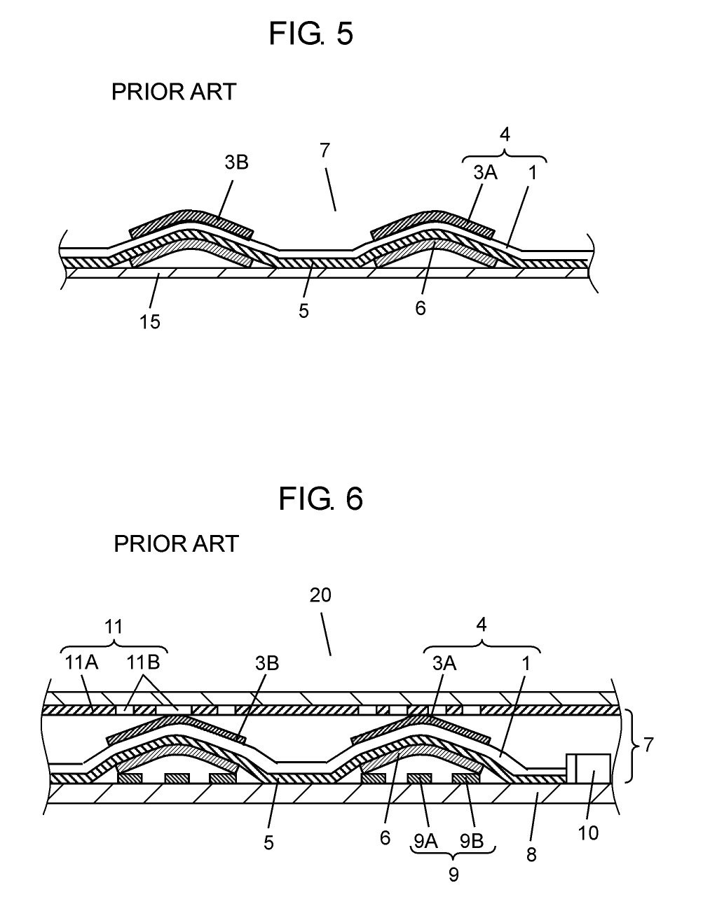

Hereinafter, a light guide sheet, a movable contact unit, and a switch of the present invention are described with reference to FIGS. 1, 2, 3 and 4. Note here that FIGS. 1, 2, 3 and 4 are shown on an expanded scale partially for an easy understanding of configuration. Furthermore, the same numerals are given to the same components as those in FIGS. 5 and 6, and detailed description thereof is omitted.

FIG. 1 is a partial sectional view showing a movable contact unit to be described prior to an embodiment of the present invention. FIG. 2 is a partial sectional view showing a switch to be described prior to an embodiment of the present invention. Convex light emitting section 2A and light emitting section 2B are provided on the lower surface of base material 1 of light guide sheet 4 in FIGS. 5 and 6, thus forming movable contact unit 40 shown in FIG. 1. Movable contact unit 40 and wiring board 8 having fixed contact 9 and light emitting device 10 form switch 50.

Light emitting device 10 typically uses an emitted light color of blue or white. The white emitted light color is generally formed by mixing blue color and yellow color.

Light from light emitting device 10, which is dispersed and reflected in light emitting section 2A and light emitting section 2B, passes through phosphor layer 3A and phosphor layer 3B formed in the upper part of light emitting device 10, and thereby it is converted into light of a red color or a green color. Then, display section 11B located in the upper part is illuminated by such different colors.

Red light and green light have a longer wavelength of light and lower energy than those of blue light. The blue light included in light emitting device 10 is converted into a red color or a green color with the fluorescent pigment included in phosphor layer 3A and phosphor layer 3B.

When convex light emitting section 2A and light emitting section 2B are provided, a large amount of light can be reflected, so that bright and uniform illumination can be carried out. Also in this configuration, however, the light that has passed through phosphor layer 3A or phosphor layer 3B may lack in vividness.

Then, light guide sheet 113 capable of giving a vivid color in accordance with the present invention is described.

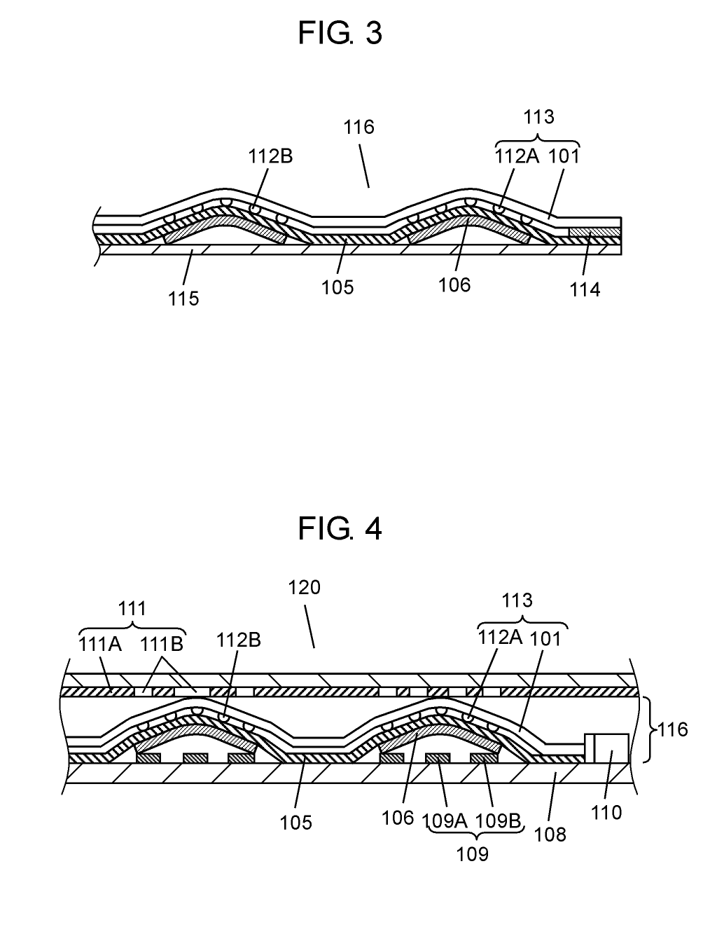

FIG. 3 is a partial sectional view showing a movable contact unit in accordance with an embodiment of the present invention. Light guide sheet 113 includes base material 101 and convex light emitting sections 112A formed on base material 101. Furthermore, movable contact unit 116 includes light guide sheet 113, base sheet 105 and dome-shaped conductive movable contacts 106.

On the predetermined portions of the lower surface of base material 101, convex light emitting section 112A (first light emitting section) and light emitting section 112B (second light emitting section), which is in a synthetic resin such as polyester and epoxy and in which a fluorescent pigment and a dyeing pigment are dispersed, are formed in dots by, for example, printing. Thus, light guide sheet 113 is formed. Base material 101 is a light-transmissive film-shaped base material having flexibility, and is made of polyurethane, silicone, styrene, polycarbonate, and the like.

In light emitting section 112A and light emitting section 112B, a fluorescent pigment and a dyeing pigment are dispersed. In light emitting section 112A, a fluorescent pigment absorbing a first color (for example, blue color) and emitting light of a second color (for example, red color) is dispersed. For example, a fluorescent pigment obtained by adding samarium fluoride to zinc sulfide or a fluorescent pigment obtained by adding europium to ytterbium oxide is dispersed in light emitting section 112A. In addition, in light emitting section 112A, anthraquinone or azo dyeing pigment of a red color, which absorbs a green color that is a complementary color of the second color (for example, red color), is dispersed.

In light emitting section 112B, a fluorescent pigment absorbing a first color (for example, blue color) and emitting light of a third color (for example, green color) is dispersed. For example, a fluorescent pigment obtained by adding ytterbium fluoride to zinc sulfide or a fluorescent pigment obtained by adding cerium and terbium to magnesium aluminate is dispersed in light emitting section 112B. In addition, in light emitting section 112B, a dyeing pigment of a green color, such as phthalocyanine green, which absorbs a red color that is a complementary color of the third color (for example, green color) is dispersed.

Base sheet 105 is attached to the lower surface of light guide sheet 113 on a predetermined portion of the periphery thereof with acrylic or silicone adhesive 114. Movable contact 106 is attached to the lower surface of base sheet 105 on the lower part of light emitting section 112A and light emitting section 112B. Base sheet 105 is film-shaped and flexible and is made of polyethylene terephthalate, polycarbonate, and the like. Movable contact 106 is a dome-shaped conductive thin plate of a copper alloy, steel, and the like.

Film-shaped separator 115 of polyethylene terephthalate and the like is attached so as to cover an entire surface of the lower surface of base sheet 105. Separator 115 prevents dust and the like from adhering to the lower surface of movable contact 106 during storage and transportation. Thus, movable contact unit 116 is configured.

FIG. 4 is a partial sectional view showing a switch in accordance with an embodiment of the present invention. Switch 120 includes movable contact unit 116 shown in FIG. 3 and wiring board 108.

On the top surface of wiring board 108, a plurality of fixed contacts 109 made of copper, carbon, and the like, are provided. Fixed contact 109 includes circular center fixed contact 109A and horseshoe-shaped or ring-shaped outer fixed contact 109B surrounding center fixed contact 109A.

Wiring board 108 is formed of a film of polyethylene terephthalate, polycarbonate, and the like, or formed of paper phenol, glass epoxy, and the like. A plurality of wiring patterns (not shown) made of copper and the like are formed on the top and lower surfaces of wiring board 108.

On the top surface of wiring board 108, movable contact unit 116 from which separator 115 (see FIG. 3) is peeled off is attached. At this time, the outer periphery of each movable contact 106 is placed on outer fixed contact 109B, and the center of the lower surface of movable contact 106 faces center fixed contact 109A with a predetermine gap therebetween.

Light emitting device 110 such as a light emitting diode that emits light of a white color or a blue color is mounted at the side part of light guide sheet 113 on the top surface of wiring board 108, and, for example, it is disposed on the right end surface face of base material 101.

In addition, on the lower surface of light-transmissive film-shaped display sheet 111, coated section 111A formed by, for example, printing and display section 111B formed by punching predetermined portions of coated section 111A in shapes of, for example, characters and symbols. Display sections 111B are disposed in the upper part of light emitting section 112A or light emitting section 112B of light guide sheet 113. Thus, switch 120 is configured.

The thus configured switch 120 is equipped on an operation surface of an electronic device such as a mobile phone, and a plurality of center fixed contacts 109A, outer fixed contacts 109B, and light emitting device 110 are connected to an electronic circuit (not shown) of the electronic device via wiring pattern, and the like.

In the above-mentioned configuration, when a user presses down a predetermined display section 111B of display sheet 111, light guide sheet 113 and base sheet 105 bend, so that dome-shaped center part of movable contact 106 is pressed down. When a predetermined pressing force is applied, movable contact 106 is elastically reversed downward with a click feeling, so that the center of the lower surface of movable contact 106 is brought into contact with center fixed contact 109A. As a result, center fixed contact 109A and outer fixed contact 109B are electrically connected to each other via movable contact 106.

Furthermore, when the pressing force applied to display sheet 111 is released, movable contact 106 is elastically reversed upward by an elastic returning force, so that the center of the lower surface of movable contact 106 departs from center fixed contact 109A. Center fixed contact 109A and outer fixed contact 109B are electrically disconnected from each other.

In response to the electrical connection/disconnection of fixed contacts 109, switching of various functions of the electronic device is carried out. Furthermore, when electric power is supplied to light emitting devices 110 from an electronic circuit of the electronic device, light emitting device 110 emits light of a white color or a blue color, and the light enters into light guide sheet 113 from, for example, the right end surface and moves to the left in base material 101 while it is reflected.

Furthermore, this light is dispersed and reflected in light emitting section 112A or light emitting section 112B on the lower surface of base material 101, and is absorbed by a fluorescent pigment. Thereby, the fluorescent pigment emits light and lights display section 111B of display sheet 111 from the lower part so as to illuminate a plurality of display sections 111B. Thus, a user can recognize displays such as characters or symbols on display sections 111B even in dark surroundings, so that the user can operate switch 120 easily.

As mentioned above, in light emitting section 112A, a fluorescent pigment absorbing a blue color and emitting light of a red color and a dyeing pigment absorbing a green color that is a complementary color of red are dispersed. Therefore, the fluorescent pigment increases the red color component, and the dyeing pigment decreases colors other than red. As a result, light emitting section 112A emits light of a pure and vivid red color.

Furthermore, in light emitting section 112B, a fluorescent pigment absorbing a blue color and emitting light of a green color, and a dyeing pigment absorbing a red color that is a complementary color of green are dispersed. Therefore, the fluorescent pigment increases the green color component and, the dyeing pigment decreases colors other than green. As a result, light emitting section 112B emits light of a pure and vivid green color. Display sections 111B are illuminated with such different emitted light colors.

That is to say, light emitting section 112A or light emitting section 112B is formed in which a fluorescent pigment absorbing a first color and emitting light of a second color, and a dyeing pigment absorbing a complementary color of the second color are dispersed. Thus, light emitting section 112A and light emitting section 112B themselves emit light of, for example, vivid red color, green color, or the like, which is different from the color of light emitted from light emitting device 110, that is, a white color or a blue color. As a result, a plurality of display sections 111B can be illuminated variously.

In this way, light emitting section 112A and light emitting section 112B themselves are formed so as to emit light of a vivid red color or a green color. Therefore, it is not necessary to provide a layer (phosphor layer) for converting the light from light emitting device 110 into a different color on the top surface of base material 101 in the upper part of light emitting section 112A or light emitting section 112B. As mentioned above, for illuminating light of two colors, i.e., a red color and a green color, light emitting section 112A for emitting a light of a red color is formed by printing on the lower surface of base material 101, and then light emitting section 112B for emitting light of a green color is formed by printing. Thus, a light guide sheet can be produced only by two times of printing operations. That is to say, the time of printing is just a number of emitted light colors to illuminate display section 111B.

In this way, according to this embodiment, a fluorescent pigment and a dyeing pigment are dispersed in convex light emitting sections 112A and light emitting sections 112B formed on base material 101. The fluorescent pigment increases a component of a certain color. The dyeing pigment decreases a component of a complementary color of the certain color. That is to say, light is emitted not by a phosphor layer but by the fluorescent pigment and the dyeing pigment. As a result, it is possible to obtain not a blurry color but a pure and vivid color.

Note here that light from light emitting device 110 is dispersed and reflected in light emitting sections 112A and light emitting sections 112B and is absorbed by the fluorescent pigment. Thus, the fluorescent pigment emits light so as to light display section 111B of display sheet 111 from the lower part, thus illuminating a plurality of display sections 111B. The fluorescent pigment absorbs a first color and emits light of a second color, and the dyeing pigment absorbs a complementary color of the second color at this time.

Herein, it is preferable that the second color is set to a color including a component having a longer wavelength of light and lower energy than those of the first color because the function of the fluorescent pigment is achieved efficiently.

Therefore, in the present invention, it is particularly effective that the first color is set to blue or white and the second color is set to red or green, but the colors are not necessarily limited thereto. Furthermore, since blue, red, and green colors are visually distinguished from each other vividly, they are suitable for a user.

Note here that in the above description, a configuration in which base sheet 105, which has a plurality of movable contacts 6 attached to the lower surface thereof, is attached to the lower surface of light guide sheet 113 is described. However, when a plurality of movable contacts 106 are directly attached to the lower surface of light guide sheet 113 without providing base sheet 105, the total number of components can be reduced, thus enabling movable contact unit 116 or switch 120 to be formed in more simple and easy manner and at low cost.

As mentioned above, according to this embodiment, light guide sheet 113 for emitting light of a pure and vivid color, and movable contact unit 116 and switch 120 using the light guide sheet 113 are obtained, and are useful mainly for operating various electronic devices.

What is claimed is:

1. A light guide sheet, comprising:
a light-transmissive film-shaped base material; and
a convex first light emitting section formed on the base material,
wherein a fluorescent pigment and a dyeing pigment are dispersed in the first light emitting section.

2. The light guide sheet of claim 1,
wherein the fluorescent pigment absorbs a first color and emits light of a second color, and
the dyeing pigment absorbs a complementary color of the second color.

3. The light guide sheet of claim 2, further comprising:
a convex second light emitting section formed on the base material,
wherein a fluorescent pigment absorbing the first color and emitting light of a third color and a dyeing pigment absorbing a complementary color of the third color are dispersed in the second light emitting section.

4. A movable contact unit, comprising:
a light guide sheet including:
a light-transmissive film-shaped base material; and
a convex light emitting section formed on the base material, wherein a fluorescent pigment and a dyeing pigment are dispersed in the light emitting section, and
a dome-shaped conductive movable contact,
wherein a surface of the light guide sheet on which the light emitting section is formed faces the movable contact directly or indirectly.

5. A switch comprising;
a movable contact unit including;
a light guide sheet that includes;
a light-transmissive film-shaped base material, and
a convex light emitting section formed on the base material, wherein a fluorescent pigment and a dyeing pigment are dispersed in the light emitting section, and
a dome-shaped conductive movable contact;
a fixed contact, and
a wiring board having a light emitting device,
wherein a surface of the light guide sheet on which the light emitting section is formed faces the movable contact directly or indirectly.
